(19) United States
(12) Patent Application Publication
(10) Pub. No.: US 2026/0205443 A1
(43) Pub. Date: Jul. 16, 2026

(54) DOCUMENT DELIVERY THROUGH VERY SMART WALLETS

(71) Applicant: Wells Fargo Bank, N.A., San Francisco, CA (US)

(72) Inventors: Clifford R. Bloom, Minneapolis, MN (US); Mary P. Casey, Edina, MN (US); Ryan Michael Hegland, Lakeville, MN (US); Eric J. Milller, Minneapolis, MN (US)

(21) Appl. No.: 19/025,086

(22) Filed: Jan. 16, 2025

(51) Int. Cl. H04L 9/40; G06Q 20/36

(52) U.S. Cl. CPC H04L 63/04; G06Q 20/36; H04L 63/08

(57) ABSTRACT

Methods for secure document delivery using a mobile wallet application are disclosed. The method includes receiving a request for a verification document, identifying the document source, and interfacing with the document source to retrieve the document. The interfacing process involves authenticating with the document source using a digital identity stored in the mobile wallet, transmitting a request for the document, and receiving the document or a link to it. The method further includes establishing a secure communication channel with the requestor system and transmitting the document or link via this channel. This approach enhances security, efficiency, and convenience in document delivery.

### TECHNICAL FIELD

Embodiments pertain to digital document management systems. Some embodiments relate to secure document delivery through mobile wallet applications.

### BACKGROUND

Mobile devices and digital wallets have become increasingly prevalent in modern society, transforming the way individuals manage their personal information and conduct transactions. These technologies have streamlined various aspects of daily life, from making payments to storing loyalty cards and boarding passes. As the capabilities of mobile devices continue to expand, they are serving additional functions beyond basic financial transactions.

The digital transformation of personal documentation and identification is an emerging trend in this technological landscape. Digital identifications stored in mobile wallets such as mobile driver's licenses (mDLs) represent one such innovation, offering a secure digital alternative to traditional physical identification documents. This shift towards digital credentials has changed how individuals interact with various institutions and service providers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for secure document delivery using a mobile wallet according to some examples of the present disclosure.

FIG. 2 illustrates a system for secure document delivery using a mobile wallet according to some examples of the present disclosure.

FIG. 3 shows a logical diagram of the components of a user device, a requestor device, a document source lookup service, and an information source device according to some examples of the present disclosure.

FIG. 4 shows a flowchart of a method of providing documents through a mobile wallet delivery mechanism using a digital identification according to some examples of the present disclosure.

FIG. 5 illustrates a flowchart of a method of a document source service according to some examples of the present disclosure.

FIG. 6 shows a flowchart of a method of a document source server responding to a document request according to some examples of the present disclosure.

FIG. 7 shows a flowchart of a method of a document requestor requesting and receiving a document through a mobile wallet according to some examples of the present disclosure.

FIG. 8 illustrates a block diagram of an example machine upon which any one or more of the techniques (e.g., methodologies) discussed herein may be performed.

### DETAILED DESCRIPTION

Traditional methods of providing documentation for various purposes, such as changing addresses or applying for benefit programs, often involve manual processes. Users typically gather physical documents, make copies, and either mail or hand-deliver them to the requesting party. This approach is time-consuming and prone to errors and delays. Additionally, handling sensitive documents physically increases the risk of loss or theft, compromising privacy and security.

The use of digital documents, while more convenient, comes with inherent risks. For example, digital documents can be susceptible to tampering, where unauthorized modifications can be made without detection. This compromises the integrity and authenticity of the documents, potentially leading to fraudulent activities. Additionally, digital documents can be vulnerable to cyber-attacks, where malicious actors may intercept or alter the documents during transmission. Ensuring the security and authenticity of digital documents helps maintain trust and reliability in digital transactions.

The absence of a streamlined and trusted method for document delivery creates significant inconvenience and inefficiency for users and organizations. For example, when applying for a mortgage, users provide multiple documents like bank statements and proof of income. The manual collection, copying, and delivery of these documents can take days or weeks, delaying approval processes and causing frustration for both users and requestors. While digital documents offer a more convenient alternative, a recipient may not be able to trust the authenticity of those documents. For example, a financial institution may have certain regulatory obligations that require additional verification of documents received digitally.

Disclosed in some examples are methods, systems, devices, and machine-readable mediums for streamlining document delivery, enhancing security, and improving efficiency in various application processes. The invention leverages mobile wallet technology, secure communication protocols, and integration with back-end systems to provide a seamless and secure method for storing, accessing, and transferring sensitive documents.

The mobile wallet or an application on a user's mobile device may interface with a requestor system that is requesting verification documents. Example verification documents include bank statements, utility payments, and the like. The application or mobile wallet can then interface with document sources, such as other applications on the same device (e.g., a banking application), back-end systems, or third-party systems to obtain the requested documentation. The digital identification in the mobile wallet may be used as proof to these document sources that the request is legitimate.

In some examples, the digital identifier may be sent to the requestor and used as proof to the requestor that the person presenting the documents is legitimate. In some examples, the documents may be signed by a digital signature of the document source, which may be verified by the recipient by using the public key of the document source (which may be obtained from a certificate authority). This ensures that the document was not tampered with between the document source and the requestor. In some examples, there may be a protocol standard for document exchange between a requestor, the mobile wallet, and the applications, back-end servers, or third-party systems that covers the process to request, obtain, and authenticate these documents.

Use cases may include obtaining documents for financial aid (FAFSA), mortgages, car loans, apartment applications, college applications, applying for real ID, signing up for benefit cards, applying for a rental car, applying for rental housing, and the like. Example documents may include credit reports, bank statements, utility bills, insurance documents (e.g., proof of insurance), and the like.

Requests and document exchange between the requestor device and the mobile wallet may use a packet-based network, wireless, short-range wireless (e.g., WIFI, Bluetooth, NFC), or the like. In some examples, once obtained, the documents may be stored in the mobile wallet's secure environment. This may facilitate circumstances in which the documents are obtained in advance of the request from the requestor. For stored documents, users may simply use a UI of the mobile wallet to select from the stored documents from their mobile wallet and authorize their transfer to the requesting party.

In other examples, instead of transferring the documents itself, the source of the documents may provide a link to the documents which may include a token to authenticate. This link and/or token may be provided by the mobile wallet to the requesting party.

The use of a document system not only streamlines the process but also enhances security by reducing the risk of document loss or theft. In addition, by using digital identifiers, the user's request can be authenticated by the document source as well as authenticating the user to the requestor. In addition, the use of digital signatures to sign the documents by the document source may be used to ensure documents are not tampered with.

For example, when applying for a rental apartment, users can quickly provide their credit report and proof of income directly from their mobile wallet, speeding up the application process and reducing the risk of sensitive information being lost or stolen. The landlord may quickly and easily verify that the information provided is true and accurate and is from a legitimate source.

Finally, this system may also allow requestors (e.g., banks, apartment rental companies) to specify criteria related to the documents. For example, a minimum credit score. The mobile wallet may receive the documents and criteria, evaluate the criteria, and provide a trusted decision to the requestor without sharing sensitive information.

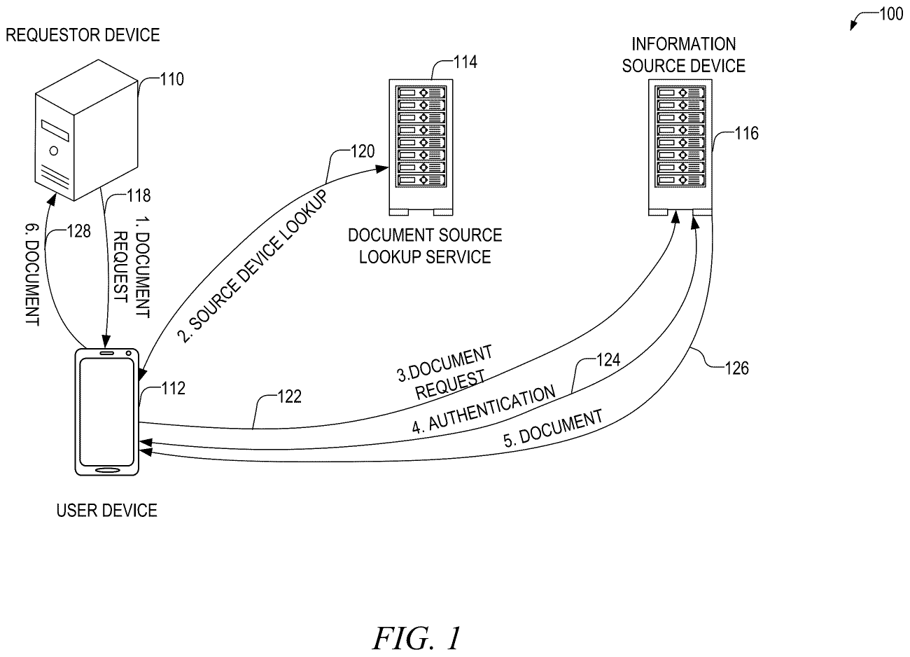

FIG. 1 illustrates a system 100 for secure document delivery using a mobile device according to some examples of the present disclosure. The figure depicts both system components and a message flow between these components. The system components shown in FIG. 1 include a requestor device 110, which represents the system requesting a verification document; a user device 112, which is illustrated as a mobile device containing the mobile wallet application; a document source lookup service 114, which helps identify the source of the requested document; and an information source device 116, which stores and provides the requested document. While the description herein uses mobile device, mobile wallet, and the like, it will be appreciated by one of ordinary skill in the art with the benefit of the present disclosure that this description is exemplary and other device types (e.g., desktops, laptops, and the like) may be used.

The message flow illustrated in FIG. 1 outlines an example process for secure document retrieval and delivery. The process begins with the requestor device 110 sending a document request 118 to the user device 112. Upon receiving the request, the user device 112 performs a source device lookup 120 to determine where to find the document. In some examples, instead of a request to an external service (as is shown in FIG. 1), this may be done wholly, or in part, on the user device 112, using a source table or lookup table. In other examples, and as shown by the figure, this may be done by communicating with the document source lookup service 114. Document source lookup service 114 may have a lookup table that determines, for each type of document requested, an address or link to a device that has the document. For example, a bank statement request will be routed to a document server for the bank that handles requests for bank statements through this process. This lookup process helps identify the appropriate information source device, such as information source device 116 that holds the requested document. In some examples, multiple document sources may be identified. In these examples, all the matching sources may be sent back to the user device 112. The user device 112 may display the matching sources and the user of the device may select which source to utilize.

After identifying the appropriate information source device 116, the user device 112 sends a document request 122 to the information source device 116. The user device 112 then authenticates 124 with the information source device 116. In some examples, this may use the digital identity stored in the mobile wallet application. The digital identity is issued to the mobile wallet from an identity provider system (not shown) and signed by that system. The information source device 116 may verify the identity by ensuring that the signed identity information is valid. Furthermore, the information source device 116 may consult its rules to determine if the user that is requesting the document has permission to access the document.

Following successful authentication and permissions checks, the information source device 116 sends the requested document 126 to the User Device 112. The document may be signed by the information source device 116. The user device 112 then forwards the document 126 to the requestor device 110, completing the primary document delivery process. This secure transmission ensures that the sensitive information contained in the verification document is protected throughout the delivery process. The user device 112 may then provide the document to the requestor device 110 using message 128. In some examples, the requestor device 110 verifies the document has not been tampered with by verifying the cryptographic hash in the cryptographic signature provided by the information source device 116.

The system depicted in FIG. 1 leverages the mobile wallet's secure environment to store and transmit sensitive documents. The use of a document source lookup service 114 allows for flexibility in retrieving documents from various sources, which could include financial institutions, utility providers, or government agencies. In some examples, a document may be obtained from alternative sources. The document source lookup service 114 may route the request between different document sources depending on a load of the document sources, or the like. The authentication process 124 between the user device 112 and the information source device 116 may utilize advanced encryption techniques to ensure the security of the digital identity and the requested document.

In some examples, the communication channels established between the various components (represented by the arrows in FIG. 1) may employ protocols such as HTTPS or utilize Near Field Communication (NFC) technology for short-range, secure data transfer. These technical aspects contribute to the overall security and efficiency of the document delivery system, protecting sensitive information from unauthorized access or interception.

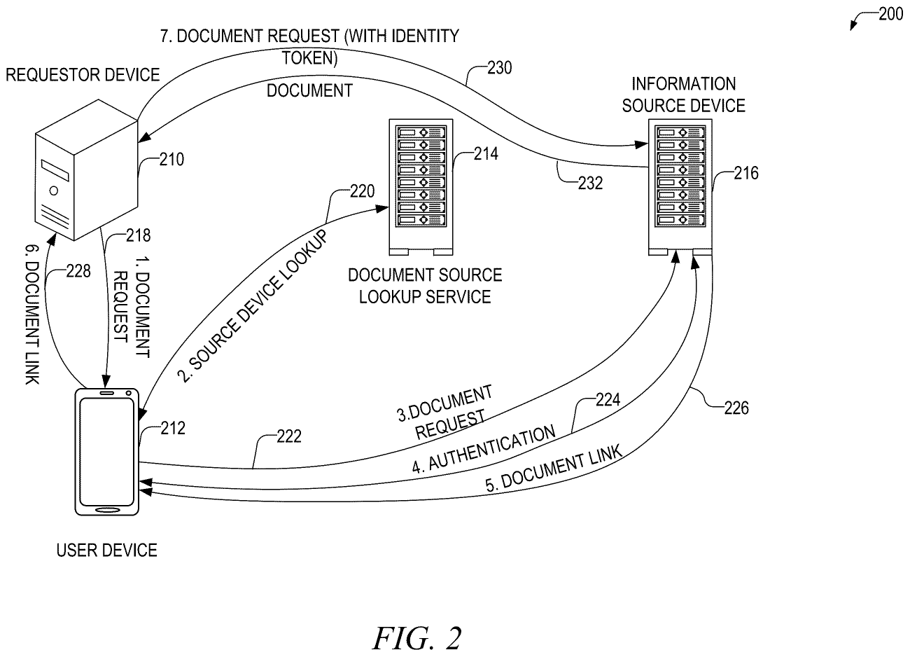

FIG. 2 illustrates a system 200 for secure document delivery using a mobile device according to some examples of the present disclosure. The figure depicts both system components and a message flow between these components. The system components shown in FIG. 2 include a requestor device 210, which represents the system requesting a verification document; a user device 212, which is the mobile device containing the mobile wallet application; a document source lookup service 214, which helps identify the source of the requested document; and an information source device 216, which stores and provides the requested document.

The message flow illustrated in FIG. 2 outlines a second example process 200 for secure document retrieval and delivery. The process 200 illustrates a scenario in which the information source device 216 and user device 212 provides a link to the requestor device 210 to obtain the documents rather than providing the documents directly.

The process begins with the requestor device 210 sending a document request 218 to the user device 212. Upon receiving the request, the user device 212 performs a source device lookup 220 to determine where to find the document. In some examples, this may be done on the user device 212, using a source table or lookup table. In other examples, and as shown by the figure, this may be done by communicating with the document source lookup service 214. Document source lookup service 214 may have a lookup table that determines, for each type of document requested, an address or link to a device that has the document. For example, a Wells Fargo bank statement request will be routed to a Wells Fargo information source device server that handles requests for bank statements through this process. This lookup process helps identify the appropriate information source device 216 that holds the requested document.

After identifying the appropriate source, the user device 212 sends a document request 222 to the information source device 216. The user device 212 then authenticates 224 with the information source device 216. In some examples, this may use the digital identity stored in the mobile wallet application. The digital identity is issued to the mobile wallet from an identity provider system (not shown) and signed by that system. The information source device 216 may verify the identity by ensuring that the signed identity information is valid. Furthermore, the information source device 216 may consult rules to determine if the user that is requesting the information has permission to access the information.

Following successful authentication and permissions checks, the information source device 216 sends a document link 226 to the user device 212. The user device 212 then forwards the document link 226 to the requestor device 210. In some examples, the document link may include an authentication token that is used by the requestor device to authenticate with the information source device 216. For example, by sending a document request 230. If the information source device 216 verifies that the authentication token is authentic, the information source device 216 may send the document back at operation 232. In some examples, the document may be signed by the information source device 216. In some examples, the user device 212 may obtain the digital identification of the requestor device 210 and provide it to the information source device 216 along with the document request 222. When the requestor device 210 requests the document with the document request 230, it may provide its digital identification. In these examples, the information source device 216 ensures that the digital identification provided in the document request 230 is valid and matches that provided by the user device 212 in the document request 222.

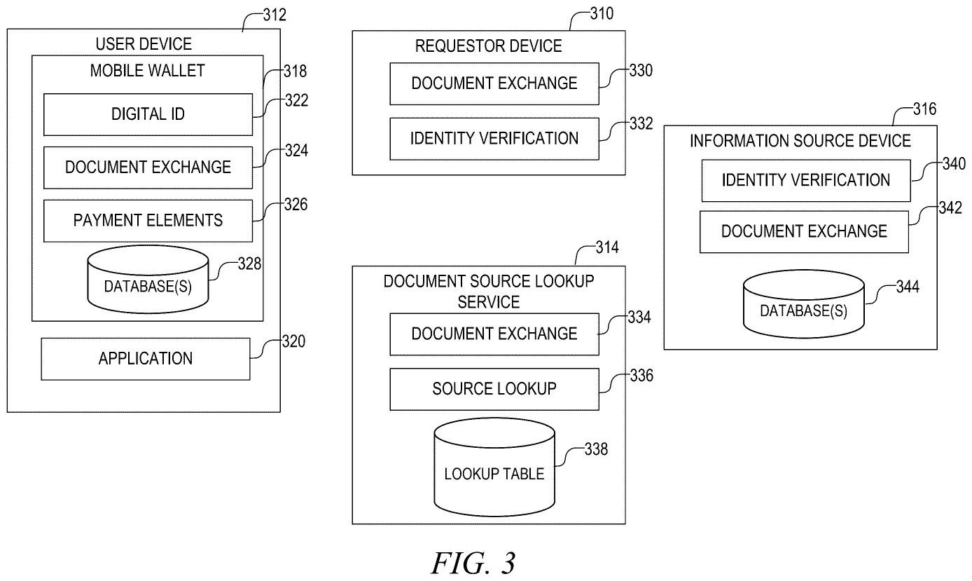

FIG. 3 shows a logical diagram of the components of a user device 312, a requestor device 310, a document source lookup service 314, and an information source device 316 according to some examples of the present disclosure. The user device 312 includes a mobile wallet 318, which serves as a central component for managing digital transactions and document exchanges. The mobile wallet 318 contains a digital ID 322, which provides a secure digital identity for authentication purposes. A document exchange component 324 facilitates the secure transfer of documents between the user device 312 and other entities. For example, by managing communications with the requestor device 310, document source lookup service 314, information source device 316, and the like. Payment elements 326 allow for financial transactions, while database(s) 328 store relevant data and documents. An application 320 interfaces with the mobile wallet 318 to execute various functions and processes, such as providing documents, in some examples (e.g., instead of directly contacting an information source device 316, the document exchange component 324 may instead obtain the document through the application 320).

The requestor device 310 comprises a document exchange component 330, which handles the request for, and receipt and processing (including authentication) of, documents from the user device 312. An identity verification component 332 ensures that the documents and the identity of the user are legitimate and authorized for the transaction.

The document source lookup service 314 includes a document exchange component 334, which manages the APIs used by the various components to lookup document sources. A source lookup component 336 identifies the appropriate source for the requested documents using a lookup table 338. The lookup table 338 contains mappings and addresses for different document sources, facilitating efficient document retrieval.

The information source device 316 features an identity verification component 340, which authenticates the identity of the user or requestor before granting access to documents (e.g., by verifying a cryptographic signature of the identity). A document exchange component 342 manages the transfer of documents to the user device 312 or requestor device 310. Database(s) 344 store the documents and related data, ensuring that the information is readily available for authorized access.

In some examples, rather than transferring documents using the mobile wallet 318, the document exchange component 324 may obtain the documents using the application 320. For example, if the application 320 is a banking application, and the requested document is a bank statement, the document exchange component 324 may have a local lookup table that maps documents to applications on the user device 312. The document exchange component 324 may then authenticate with the application 320 using the digital id 322 and request the document.

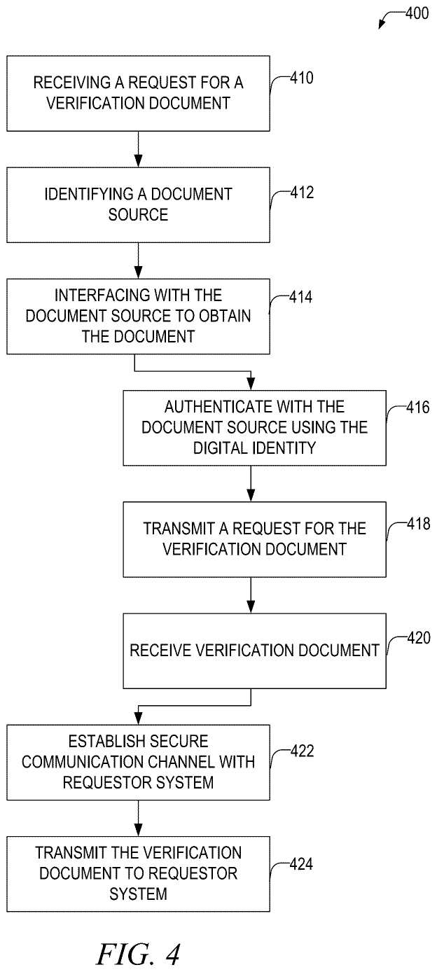

FIG. 4 shows a flowchart of a method 400 of providing documents through a mobile wallet delivery mechanism using a digital identification according to some examples of the present disclosure. At operation 410, the method begins with receiving a request for a verification document. This step involves the mobile wallet application on the user's mobile device receiving a request from a requestor system for a specific verification document. The requestor system could be any entity requiring verification documents, such as a financial institution, government agency, or service provider.

At operation 412, the method involves identifying a document source. The mobile wallet application identifies the appropriate document source system that holds the requested verification document. This identification process may involve consulting a lookup table, database, or utilizing an external service that maps document types to their respective sources.

Following the identification of the document source, at operation 414, the method proceeds to interfacing with the document source to obtain the document. The mobile wallet application establishes a connection with the document source system to retrieve the requested document. This interfacing step includes several sub-steps to ensure secure and authenticated communication. At operation 416, the first sub-step in the interfacing process is to authenticate with the document source using the digital identity. The mobile wallet application uses a digital identity stored within the mobile wallet application to authenticate with the document source system. This digital identity may be a mobile driver's license (mDL) or another form of digital identification that verifies the user's legitimacy. The digital identity may be issued by an identity issuing service and may be signed by that service.

Once authenticated, at operation 418, the mobile wallet application transmits a request for the verification document. This request is sent to the document source system, specifying the required verification document. The document source system verifies the digital identity and the authorization to access the requested document.

Upon successful verification, at operation 420, the document source system sends to, and the mobile wallet receives the requested verification document, completing the step of receiving the verification document. The document may be received directly or as a link to the document stored on the document source system.

After obtaining the verification document, at operation 422, the method involves establishing a secure communication channel with the requestor system. The mobile wallet application sets up a secure channel to ensure that the transmission of the verification document is protected from unauthorized access or interception.

At operation 424, the method concludes with transmitting the verification document to the requestor system. The mobile wallet application sends the verification document or the link to the verification document through the established secure communication channel to the requestor system. This step ensures that the requestor system receives the necessary verification document securely and efficiently.

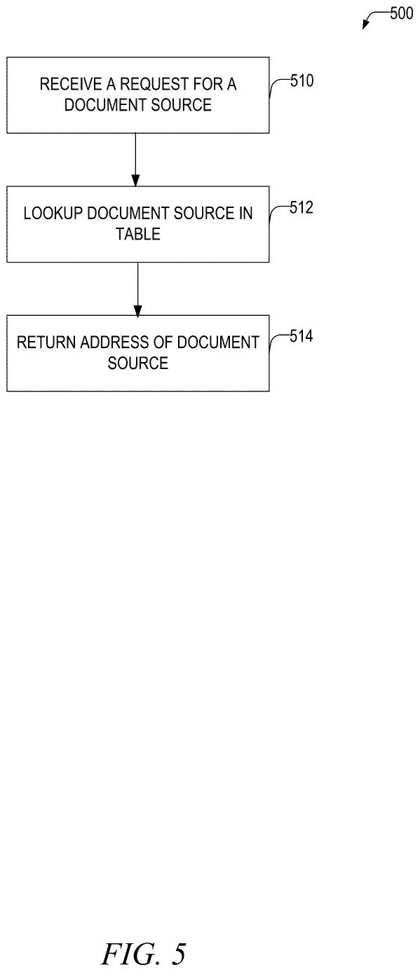

FIG. 5 illustrates a flowchart of a method 500 of a document source service according to some examples of the present disclosure. At operation 510, the method begins with receiving a request for a document source. This step involves the document source service receiving a request from a user device or another system to identify the source of a specific document. The request may include details about the type of document needed, such as a bank statement, utility bill, or proof of income.

At operation 512, the method proceeds to lookup the document source in a table. In this step, the document source service consults a lookup table or database to identify the appropriate source for the requested document. The lookup table contains mappings of document types to their respective sources, such as financial institutions, utility providers, or government agencies. This step ensures that the correct source is identified for the requested document. In some examples, the lookup table may be built based upon a subscription model in which the document service subscribes to various document sources to obtain information on the documents they have.

At operation 514, the method concludes with returning the address of the document source. In this step, the document source service returns the address or link of the identified document source to the requesting system. This address or link can then be used by the requesting system to retrieve the document from the identified source.

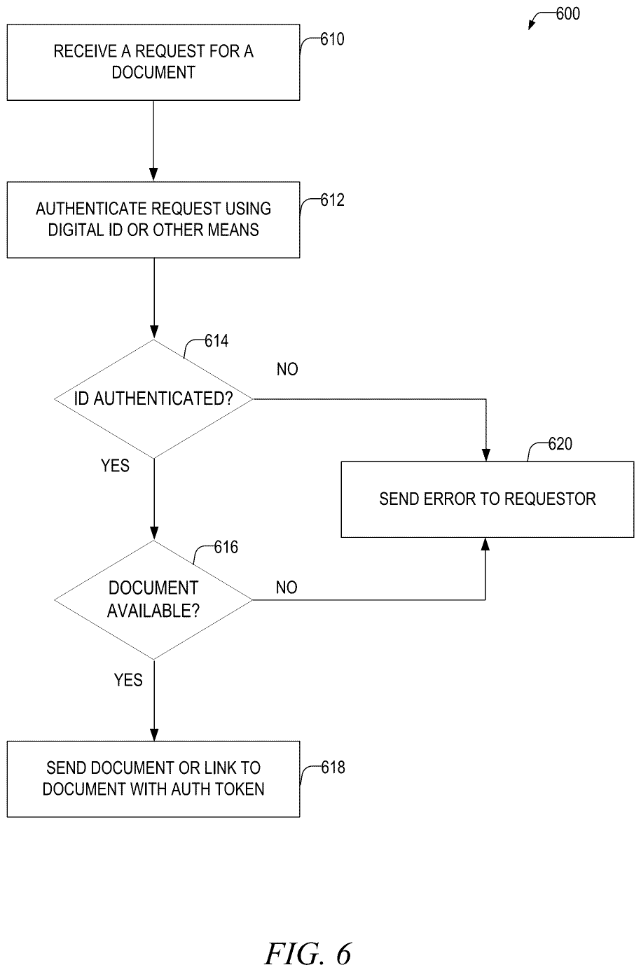

FIG. 6 shows a flowchart of a method 600 of a document source server responding to a document request according to some examples of the present disclosure. At operation 610, the method begins with receiving a request for a document. This step involves the document source server receiving a request from a user device or another system to provide a specific document. The request may include details about the type of document needed, such as a bank statement, utility bill, or proof of income.

At operation 612, the method proceeds to authenticate the request using a digital ID or other means. This step involves verifying the identity of the requester to ensure that the request is legitimate. The authentication process may use a digital identity stored within the mobile wallet application, such as a mobile driver's license (mDL) or another form of digital identification that verifies the user's legitimacy. In some examples, as part of authenticating the request, the digital ID may be authenticated by both ensuring that the digital ID is valid by checking the cryptographic signature, but also authenticating that the user whose digital ID is being presented is authorized to access the document.

At operation 614, the method checks if the ID is authenticated. If the ID is not authenticated, the method proceeds to operation 620 to send an error to the requestor. This step involves notifying the requestor that the authentication has failed, and the document cannot be provided. If the ID is authenticated, the method proceeds to operation 616 to check if the document is available. This step involves verifying whether the requested document is present in the document source system. If the document is not available, the method proceeds to operation 620 to send an error to the requestor, notifying the requestor that the document cannot be provided due to the document's unavailability.

If the document is available, the method proceeds to operation 618 to send the document or a link to the document with an authentication token. This step involves transmitting the requested document or a link to the document, along with an authentication token, to the requestor. The authentication token ensures that the requestor can securely access the document from the document source system.

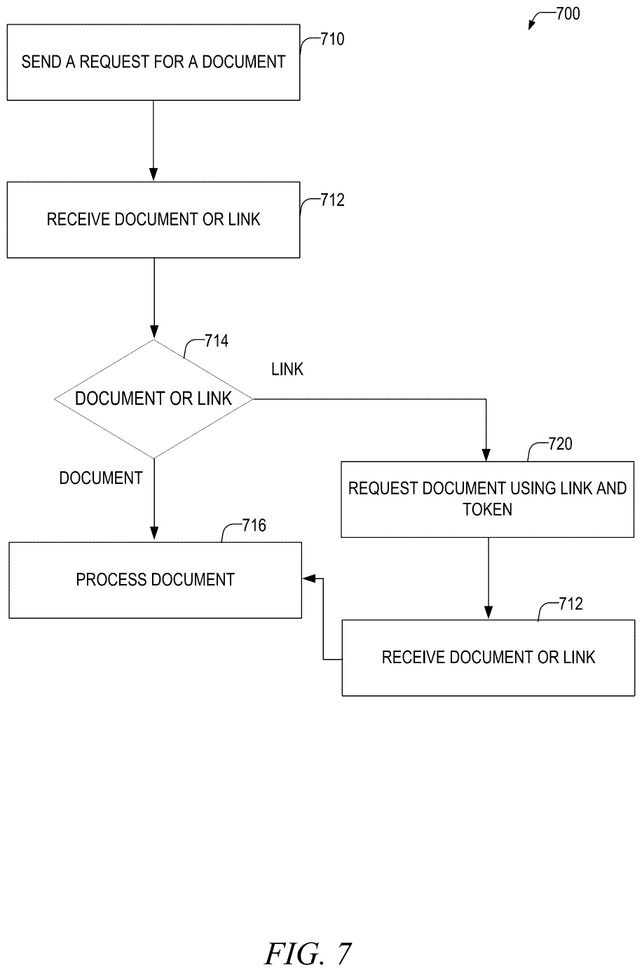

FIG. 7 shows a flowchart of a method 700 of a document requestor requesting and receiving a document through a mobile wallet according to some examples of the present disclosure. At operation 710, the method begins with sending a request for a document. This step involves the document requestor initiating a request for a specific document through the mobile wallet application. The requestor system could be any entity requiring verification documents, such as a financial institution, government agency, or service provider.

At operation 712, the method proceeds to receive the document or link. The mobile wallet application receives either the requested document directly or a link to the document from the document source system. At operation 714, the method reaches a decision point where the system determines whether the received item is a document or a link. If the received item is a document, the process moves to operation 716 to process the document. In this step, the document requestor processes the received document as required for the specific application or verification purpose.

If the received item is a link, the method advances to operation 720 to request the document using the link and token. This step involves the document requestor using the provided link and an authentication token to request the document from the document source system. The authentication token ensures that the requestor can securely access the document from the document source system. In some examples, the requestor also submits, to the document source, it's digital identification to ensure that the request is legitimate. In still other examples, when sending the request at operation 710, the requestor also provides its digital id to the mobile wallet, which provides it to the document source. In these examples, the digital identification provided to the document source in operation 720 may be required to match the digital identification provided to the mobile wallet in operation 710 to ensure additional security.

Following the request using the link and token, the method returns to operation 712 to receive the document or link. In this step, the document requestor receives the requested document or another link to the document, completing the document retrieval process.

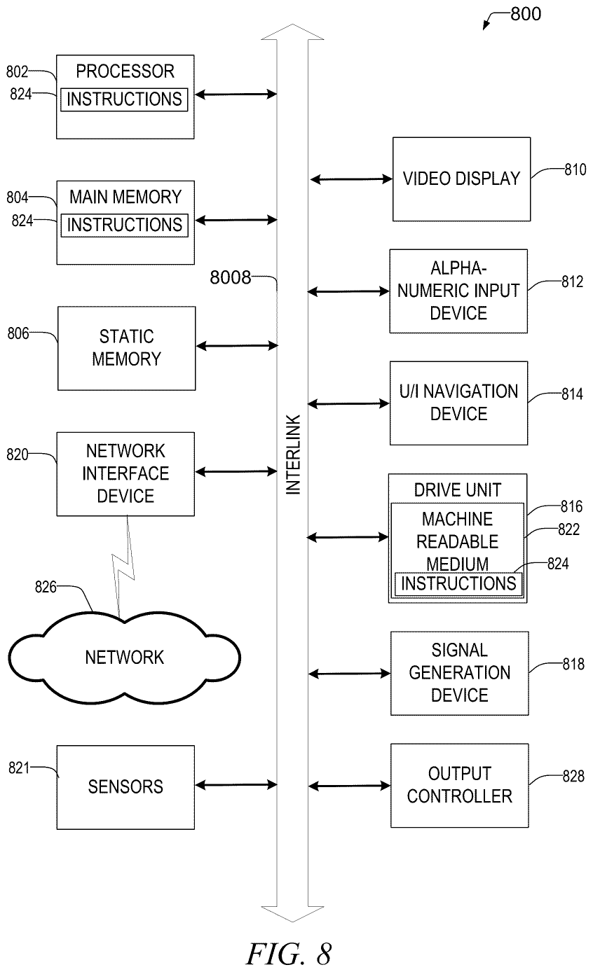

FIG. 8 illustrates a block diagram of an example machine 800 upon which any one or more of the techniques (e.g., methodologies) discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In some examples, machine 800 may be or be configured to be a user device, such as user device 112, 212, 312; a document source lookup server providing a document source lookup service 114, 214, 314; a requestor device 110, 210, 310; an information source device 116, 216, 316; or any other device described herein. The machine 800 may be configured to implement any one or more of the methods of FIGS. 4-7.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 800 may include one or more hardware processors, such as processor 802. Processor 802 may be a central processing unit (CPU), a graphics processing unit (GPU), a hardware processor core, or any combination thereof. Machine 800 may include a main memory 804 and a static memory 806, some or all of which may communicate with each other via an interlink (e.g., bus) 808. Examples of main memory 804 may include Synchronous Dynamic Random-Access Memory (SDRAM), such as Double Data Rate memory, such as DDR4 or DDR5. Interlink 808 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820. The Machine 800 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

### Other Notes and Examples

Example 1 is a method for secure document delivery using a mobile device, comprising: receiving, by a mobile wallet application on the mobile device, a request for a verification document from a requestor system; identifying, by the mobile wallet application, a document source system that has the verification document; interfacing, by the mobile wallet application, with the document source system to retrieve the verification documents, the interfacing comprising: authenticating with the document source system using a digital identity stored in the mobile wallet application; transmitting a request for the verification document; and responsive to the document source system verifying that the digital identity is authorized to receive the verification document, receiving the verification document or a link to the verification document on the document source system; establishing a secure communication channel with the requestor system; and transmitting, via the secure communication channel, the verification document or the link to the verification document.

In Example 2, the subject matter of Example 1 includes, wherein interfacing, by the mobile wallet application, with the document source system comprises accessing an application programming interface (API) of an application of the document source system, the application resident on the mobile device.

In Example 3, the subject matter of Examples 1-2 includes, wherein the link to the verification document is received, the link including an access token.

In Example 4, the subject matter of Examples 1-3 includes, receiving a digital identity from the requestor system; providing the digital identity to the document source system; and wherein the requestor system activates the link to access the verification document and provides its digital identity to authenticate with the document source system.

In Example 5, the subject matter of Examples 1-4 includes, wherein the secure communication channel is established using Near Field Communication (NFC) technology.

In Example 6, the subject matter of Examples 1-5 includes, wherein the verification document comprises a credit report, and the method further comprises: storing the credit report in a secure environment within the mobile wallet application.

In Example 7, the subject matter of Examples 1-6 includes, wherein the digital identity stored in the mobile wallet application comprises a mobile driver's license (mDL).

Example 8 is a computing device for secure document delivery using a mobile device, the computing device comprising: a hardware processor; a memory, the memory storing instructions, which when executed by the hardware processor cause the computing device to perform operations comprising: receiving, by a mobile wallet application on the mobile device, a request for a verification document from a requestor system; identifying, by the mobile wallet application, a document source system that has the verification document; interfacing, by the mobile wallet application, with the document source system to retrieve the verification documents, the interfacing comprising: authenticating with the document source system using a digital identity stored in the mobile wallet application; transmitting a request for the verification document; and responsive to the document source system verifying that the digital identity is authorized to receive the verification document, receiving the verification document or a link to the verification document on the document source system; establishing a secure communication channel with the requestor system; and transmitting, via the secure communication channel, the verification document or the link to the verification document.

In Example 9, the subject matter of Example 8 includes, wherein the operations further comprise accessing an application programming interface (API) of an application of the document source system, the application resident on the mobile device.

In Example 10, the subject matter of Examples 8-9 includes, wherein the link to the verification document is received, the link including an access token.

In Example 11, the subject matter of Examples 8-10 includes, wherein the operations further comprise: receiving a digital identity from the requestor system; providing the digital identity to the document source system; and wherein the requestor system activates the link to access the verification document and provides its digital identity to authenticate with the document source system.

In Example 12, the subject matter of Examples 8-11 includes, wherein the secure communication channel is established using Near Field Communication (NFC) technology.

In Example 13, the subject matter of Examples 8-12 includes, wherein the verification document comprises a credit report, and the operations further comprise: storing the credit report in a secure environment within the mobile wallet application.

In Example 14, the subject matter of Examples 8-13 includes, wherein the digital identity stored in the mobile wallet application comprises a mobile driver's license (mDL).

Example 15 is a machine-readable medium, storing instructions for secure document delivery using a mobile device, the instructions, which when executed, cause the machine to perform operations comprising: receiving, by a mobile wallet application on the mobile device, a request for a verification document from a requestor system; identifying, by the mobile wallet application, a document source system that has the verification document; interfacing, by the mobile wallet application, with the document source system to retrieve the verification documents, the interfacing comprising: authenticating with the document source system using a digital identity stored in the mobile wallet application; transmitting a request for the verification document; and responsive to the document source system verifying that the digital identity is authorized to receive the verification document, receiving the verification document or a link to the verification document on the document source system; establishing a secure communication channel with the requestor system; and transmitting, via the secure communication channel, the verification document or the link to the verification document.

In Example 16, the subject matter of Example 15 includes, wherein the operations further comprise accessing an application programming interface (API) of an application of the document source system, the application resident on the mobile device.

In Example 17, the subject matter of Examples 15-16 includes, wherein the link to the verification document is received, the link including an access token.

In Example 18, the subject matter of Examples 15-17 includes, wherein the operations further comprise: receiving a digital identity from the requestor system; providing the digital identity to the document source system; and wherein the requestor system activates the link to access the verification document and provides its digital identity to authenticate with the document source system.

In Example 19, the subject matter of Examples 15-18 includes, wherein the secure communication channel is established using Near Field Communication (NFC) technology.

In Example 20, the subject matter of Examples 15-19 includes, wherein the verification document comprises a credit report, and the operations further comprise: storing the credit report in a secure environment within the mobile wallet application.

In Example 21, the subject matter of Examples 15-20 includes, wherein the digital identity stored in the mobile wallet application comprises a mobile driver's license (mDL).

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for secure document delivery using a mobile device, comprising:
receiving, by a mobile wallet application on the mobile device, a request for a verification document from a requestor system;
identifying, by the mobile wallet application, a document source system that has the verification document;
interfacing, by the mobile wallet application, with the document source system to retrieve the verification documents, the interfacing comprising:
authenticating with the document source system using a digital identity stored in the mobile wallet application;
transmitting a request for the verification document; and
responsive to the document source system verifying that the digital identity is authorized to receive the verification document, receiving the verification document or a link to the verification document on the document source system;
establishing a secure communication channel with the requestor system; and
transmitting, via the secure communication channel, the verification document or the link to the verification document.

2. The method of claim 1, wherein interfacing, by the mobile wallet application, with the document source system comprises accessing an application programming interface (API) of an application of the document source system, the application resident on the mobile device.

3. The method of claim 1, wherein the link to the verification document is received, the link including an access token.

4. The method of claim 1, further comprising:
receiving a digital identity from the requestor system;
providing the digital identity to the document source system; and
wherein the requestor system activates the link to access the verification document and provides its digital identity to authenticate with the document source system.

5. The method of claim 1, wherein the secure communication channel is established using Near Field Communication (NFC) technology.

6. The method of claim 1, wherein the verification document comprises a credit report, and the method further comprises:
storing the credit report in a secure environment within the mobile wallet application.

7. The method of claim 1, wherein the digital identity stored in the mobile wallet application comprises a mobile driver's license (mDL).

8. A computing device for secure document delivery using a mobile device, the computing device comprising: a hardware processor; a memory, the memory storing instructions, which when executed by the hardware processor cause the computing device to perform operations comprising:
receiving, by a mobile wallet application on the mobile device, a request for a verification document from a requestor system;
identifying, by the mobile wallet application, a document source system that has the verification document; interfacing, by the mobile wallet application, with the document source system to retrieve the verification documents, the interfacing comprising:
authenticating with the document source system using a digital identity stored in the mobile wallet application; transmitting a request for the verification document; and
responsive to the document source system verifying that the digital identity is authorized to receive the verification document, receiving the verification document or a link to the verification document on the document source system;
establishing a secure communication channel with the requestor system; and
transmitting, via the secure communication channel, the verification document or the link to the verification document.

9. The computing device of claim 8, wherein the operations further comprise accessing an application programming interface (API) of an application of the document source system, the application resident on the mobile device.

10. The computing device of claim 8, wherein the link to the verification document is received, the link including an access token.

11. The computing device of claim 8, wherein the operations further comprise: receiving a digital identity from the requestor system; providing the digital identity to the document source system; and wherein the requestor system activates the link to access the verification document and provides its digital identity to authenticate with the document source system.

12. The computing device of claim 8, wherein the secure communication channel is established using Near Field Communication (NFC) technology.

13. The computing device of claim 8, wherein the verification document comprises a credit report, and the operations further comprise: storing the credit report in a secure environment within the mobile wallet application.

14. The computing device of claim 8, wherein the digital identity stored in the mobile wallet application comprises a mobile driver's license (mDL).

15. A machine-readable medium, storing instructions for secure document delivery using a mobile device, the instructions, which when executed, cause the machine to perform operations comprising:
receiving, by a mobile wallet application on the mobile device, a request for a verification document from a requestor system;
identifying, by the mobile wallet application, a document source system that has the verification document;
interfacing, by the mobile wallet application, with the document source system to retrieve the verification documents, the interfacing comprising:
authenticating with the document source system using a digital identity stored in the mobile wallet application;
transmitting a request for the verification document; and
responsive to the document source system verifying that the digital identity is authorized to receive the verification document, receiving the verification document or a link to the verification document on the document source system;
establishing a secure communication channel with the requestor system; and
transmitting, via the secure communication channel, the verification document or the link to the verification document.

16. The machine-readable medium of claim 15, wherein the operations further comprise accessing an application programming interface (API) of an application of the document source system, the application resident on the mobile device.

17. The machine-readable medium of claim 15, wherein the link to the verification document is received, the link including an access token.

18. The machine-readable medium of claim 15, wherein the operations further comprise: receiving a digital identity from the requestor system; providing the digital identity to the document source system; and wherein the requestor system activates the link to access the verification document and provides its digital identity to authenticate with the document source system.

19. The machine-readable medium of claim 15, wherein the secure communication channel is established using Near Field Communication (NFC) technology.

20. The machine-readable medium of claim 15, wherein the verification document comprises a credit report, and the operations further comprise: storing the credit report in a secure environment within the mobile wallet application.

21. The machine-readable medium of claim 15, wherein the digital identity stored in the mobile wallet application comprises a mobile driver's license (mDL).
